(19) United States
(12) Patent Application Publication
(10) Pub. No.: US 2025/0142069 A1
(43) Pub. Date: May 1, 2025

(54) A MULTI-TRY ENCODING OPERATION FOR STREAMING APPLICATIONS

(71) Applicant: GOOGLE LLC, Mountain View, CA (US)

(72) Inventors: Danny Hong, New York, NY (US); Yinqing Zhao, Palo Alto, CA (US); Ramachandra Tahasildar, Cupertino, CA (US); In Suk Chong, Mountain View, CA (US)

(21) Appl. No.: 18/683,383

(22) PCT Filed: Sep. 3, 2021
(86) PCT No.: PCT/US2021/048997

§ 371 Date: Feb. 13, 2024

(51) Int. Cl. H04N 19/126; A63F 13/52; H04N 19/14; H04N 19/164; H04N 19/172

(52) U.S. Cl. CPC H04N 19/126; A63F 13/52; H04N 19/14; H04N 19/164; H04N 19/172

(57) ABSTRACT

A multi-try encoding operation is implemented to encode one or more game frames into a game stream. The multi-try encoding operation includes determining an initial quantization parameter for a current frame. From the determined initial quantization parameter, one or more alternative quantization parameters are derived. Multiple encoders then perform multiple encodings on the current frame based on the initial quantization parameter and the alternative quantization parameters, respectively, to produce a plurality of encoded frames. An applicable encoded frame is then selected from the plurality of encoded frames according to a streaming application. The applicable encoded frame is then transmitted as part of a game stream to a client system.

### BACKGROUND

Cloud-based gaming platforms involve executing portions of or entire video game applications on remote servers to facilitate playing the video game application on a local client device. The remote servers provide audio and video rendered from executing video game applications as audio and video streams over a network to the local client device. In providing these audio and video streams, the remote servers employ the use of various encoder operations to compress gaming frames and audio in real-time before they are streamed. For low-latency cloud gaming applications, it is desirable to ensure that the encoder operations do not compress a gaming frame at a number of bits that will cause the stream to need more bandwidth than the available network allows.

Unlike general video streaming applications where some delay is tolerated, cloud-based gaming requires that real-time interactivity be maintained. To address this, some cloud-based gaming platforms call for every frame to be encoded very close to a target frame size that matches the currently available network bandwidth. Encoding the frame at a size other than the target frame size can result in either undershooting (resulting in less bits than allowed) or overshooting (resulting in more bits than allowed), with overshooting potentially leading to packet losses and delays that degrade the gaming experience.

### SUMMARY

According to an example embodiment, a computer-implemented method can include determining an initial quantization parameter associated with a first frame of a set of frames. Additionally, the method can include deriving an alternative quantization parameter for the first frame based on the initial quantization parameter. Accordingly, an alternative quantization parameter for the first frame may be derived by using the initial quantization parameter as a start value for determining the alternative quantization. This may, for example, include determining one or more deltas (delta values) to be added to or subtracted from the initial quantization parameter for the first frame for determining the one or more alternative quantization parameters. The method may also include performing both a first encoding of the first frame based on the initial quantization parameter to produce a first encoded frame and a second encoding of the first frame based on the alternative quantization parameter to produce a second encoded frame. Both the first and second encodings may thus be performed by using the initial quantization parameter or alternative quantization parameter, respectively in an encoding operation. The method can additionally include selecting between the first encoded frame and the second encoded frame for transmission as part of an encoded game stream in response to a comparison of the first encoded frame and the second encoded frame to a target frame size. Also, the method can include transmitting the encoded game stream. Based on the disclosed solution a multi-try encoding process may be proposed including selecting an applicable encoded frame from multiple encoded frames for inclusion in a resulting game stream.

In the method, determining the initial quantization parameter can include performing a first pass encoding on the first frame to produce a first pass encoded frame and determining the initial quantization parameter using the first pass encoded frame. Further, the method can include determining an estimated complexity for the first frame based on a statistic of the first pass encoded frame and determining the initial quantization parameter based upon the estimated complexity. Accordingly, the method can include determining an estimated complexity for the first frame by at least one parameter of a determined statistic of the first pass encoded frame being indicative for an amount or value of information in a frame that differs from one or more reference frames associated with the frame (e.g., used to encode the frame). The determined statistic of the first pass encoded frame may, for example, include a bit size of the first pass encoded frame, an energy of the first pass encoded frame, a signal-to-noise ratio of the first pass encoded frame, or any combination thereof. The initial quantization parameter shall then depend from the estimated complexity.

Further, in the method, deriving the alternative quantization parameter can include determining a historical complexity associated with at least one other frame of the set of frames and comparing the historical complexity to the estimated complexity of the first frame. A historical complexity may for example be determined by a complexity of at least one previously encoded frame of the set of frames (and thus of at least one encoded frame preceding the first frame). In an example embodiment, the determined historical complexity may be calculated as an average for one or more historical complexities of previously encoded frames of the set of frames and comparing this average to the estimated complexity of the first frame currently to be encoded.

Also, the method can include selecting the alternative quantization parameter from between a first candidate alternative quantization parameter and a second candidate alternative quantization parameter in response to the comparison of the historical complexity to the estimated complexity of the first frame. As an example, the first candidate alternative quantization parameter can be greater than the initial quantization parameter and the second candidate alternative quantization parameter can be less than the initial quantization parameter. Further, the method can include selecting the second alternative quantization parameter in response to the historical complexity being greater than an estimated complexity of the first frame. Additionally, the method can include selecting the first alternative quantization parameter in response to the historical complexity being less than an estimated complexity of the first frame.

In another example embodiment, a computer-implemented method can include performing a first pass encoding on a first frame of a set of frames for a streaming application and determining an initial quantization parameter based on the first pass encoding, i.e., using the result of first pass encoding. The method can also include deriving an alternative quantization parameter for the first frame based on at least one other frame of the set of frames. For example, an alternative quantization parameter for the first frame may be derived by using the initial quantization parameter as a start value for determining the alternative quantization taking into account an encoding result of at least one other frame of the set of frames. This may, for example, include determining one or more differences of the first frame to at least one previously encoded frame of the set frames and calculating an alternative quantization parameter being higher or lower than the initial quantization parameter depending on the one or more determined differences (e.g., differences in complexity). Additionally, the method may include performing a first encoding of the first frame using the initial quantization parameter to produce a first encoded frame and performing a second encoding of the first frame based on the alternative quantization parameter to produce a second encoded frame. Also, the method can include selecting between the first encoded frame and the second encoded frame for transmission as part of an encoded game stream based on the streaming application.

Further, the method can include transmitting the encoded game stream.

In the method, determining an initial quantization parameter based on the first pass encoding can include determining an estimated complexity for the first frame based on the first pass encoding. Additionally, the method can include determining a historical complexity associated with the at least one other frame and comparing the estimated complexity to the historical complexity. A historical complexity may for example be determined by a complexity of at least one previously encoded frame of the set of frames (and thus of at least one encoded frame preceding the first frame). In an example embodiment, the determined historical complexity may be calculated as an average for one or more historical complexities of previously encoded frames of the set of frames and comparing this average to the estimated complexity of the first frame currently to be encoded.

Further, the method can include determining a value for the alternative quantization parameter less than the initial quantization parameter in response to the historical complexity being greater than the estimated complexity. Also, the method may include determining a value for the alternative quantization parameter greater than the initial quantization parameter in response to the historical complexity being less than the estimated complexity.

In the method, the streaming application can include at least one of a target (frame) size (e.g., in bits), a target efficiency, a target reliability, or a target latency. For the streaming application one or more requirements, settings, or preferences may be predetermined, such as a target quality for the encoded frames, a target efficiency for the encoded frames, a target reliability for the encoded game stream, or a target latency for the encoded game stream. To help assure that, for example, a resulting encoded game stream meets these one or more requirements, settings, or preferences of the streaming application, each frame may be encoded according to a rate control scheme so that each encoded frame is compressed to be close in size to a predetermined target bit size. In an example embodiment, this may result in selecting between the first encoded frame and the second encoded frame depending on determined frame sizes for first and second frames having a size between a target frame size and a tolerance. For example, in the method, selecting between the first encoded frame and the second encoded frame for transmission in an encoded stream based on the streaming application can thus include determining a target frame size based on the streaming application and comparing each of the first and second encoded frames to the target frame size. Selecting between the first encoded frame and the second encoded frame for transmission in an encoded stream can also include selecting the encoded frame that does not exceed an allowed number of bits based on the available bandwidth.

In the method, the alternative quantization parameter can be one of a plurality of alternative quantization parameters. Accordingly, a plurality of alternative quantization parameters may be derived based on the initial quantization parameter for encoding the first frame.

Further, the method can include deriving the plurality of alternative quantization parameters according to the set of frames. In an example embodiment, different, in particular two or more, alternative quantization parameters may be calculated based on different previously encoded frames of the set of frames.

Additionally, the encoded game stream may be encoded based on a target bitrate.

The method can additionally include comparing each the first and second encoded frames to the target bitrate and selecting between the first encoded frame and the second encoded frame further in response to the comparison of each the first and second encoded frames to the target bitrate.

In general, the encoded game stream can be associated with a gaming session.

Further, the first frame can represent at least a portion of a virtual environment associated with the gaming session. Additionally, the encoded game stream may be transmitted to a client device associated with the gaming session.

Methods herein can further include decoding the encoded game stream to produce a decoded game stream and displaying the decoded game stream. Generally, the first encoding and the second encoding can both be performed within a predetermined duration. Additionally, the first encoding and the second encoding can be performed concurrently. Also, methods herein can include determining a complexity of the selected encoded frame and storing a representation of the complexity in a memory buffer. Further, methods herein can include performing a second (multi-try) encoding operation on a second frame of the set of frames using the stored representation of the complexity. Methods herein can further include determining an applicable quantization parameter of the selected encoded frame and storing the applicable quantization parameter in a memory buffer. Methods herein can also include performing a second (multi-try) encoding operation on a second frame of the set of frames using the stored applicable quantization parameter. According to embodiments, a representation of the complexity for a selected (applicable) encoded frame may thus be determined and stored in a memory buffer for use as a historical complexity in the encoding of a subsequent frame of the set of game frames. Likewise, in embodiments, a selected quantization parameter associated with the selected encoded frame (i.e., the quantization parameter used to encode the selected encoded frame) may be stored in a memory buffer for use as a historical quantization parameter in the encoding of a subsequent frame of the set of game frames.

According to example embodiments, a system can include one or more processors and a memory coupled to the one or more processors. The memory can store executable instructions configured to manipulate the one or more processors to perform the methods disclosed herein.

In additional example embodiments, a system can include a network interface couplable to a network and an encoder coupled to the network interface. The system may be configured to perform the methods disclosed herein.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a cloud-based gaming system employing a multi-try encoding technique, in accordance with some embodiments.

FIG. 2 is a block diagram of a computing device configured to encode and stream frames within a cloud-based gaming system, in accordance with some embodiments.

FIG. 3 is a flow diagram illustrating a method for a multi-try encoding of a frame of a set of frames, in accordance with some embodiments.

FIG. 4 is a flow diagram illustrating an example determination of an initial quantization parameter for multi-try encoding, in accordance with some embodiments.

FIG. 5 is a flow diagram illustrating an example selection of an applicable encoded frame for multi-try encoding, in accordance with some embodiments.

FIG. 6 is a flow diagram illustrating an example of a multi-try encoding process, in accordance with some embodiments.

### DETAILED DESCRIPTION

Techniques and systems described herein address the demands of providing a video stream from one or more servers to a client system while maintaining the requirements, settings, and preferences of the streaming application. In particular, such techniques and systems described herein allow for encoding a set of frames at a server using a multi-try encoding operation to determine an applicable quantization parameter for each frame of the set of frames based on the streaming application. To better ensure that the resulting video stream meets the requirements, settings, and preferences of the streaming application, an initial quantization parameter for each frame is determined based on an estimated complexity determined during a first pass encoding. From the initial quantization parameter, additional, alternative quantization parameters are derived for each frame based on the encoding history of previously encoded frames from the set of frames. Encoders then perform multiple encodings of each frame according to the respective initial and alternative quantization parameters to produce multiple encoded frames. An applicable encoded frame is then selected from these encoded frames according to the streaming application. In this way, each frame is more accurately allocated the number of bits needed to result in a video stream that better meets the requirements, settings, and preferences of the streaming application.

To facilitate understanding, the techniques of the present disclosure are described in the example context of a cloud gaming system. A cloud-based or other remote server renders a stream of video frames representing the visual content of a video game instance being executed at that server or a related server and then encodes each frame using a multi-try encoding process described herein to generate a bitstream representing a stream of encoded rendered game frames for transmission to one or more client devices via one or more networks. However, it will be appreciated that the systems and techniques described herein are not limited to this example context, but instead may be implemented in any of a variety of video stream encoding/decoding systems using the guidelines provided herein.

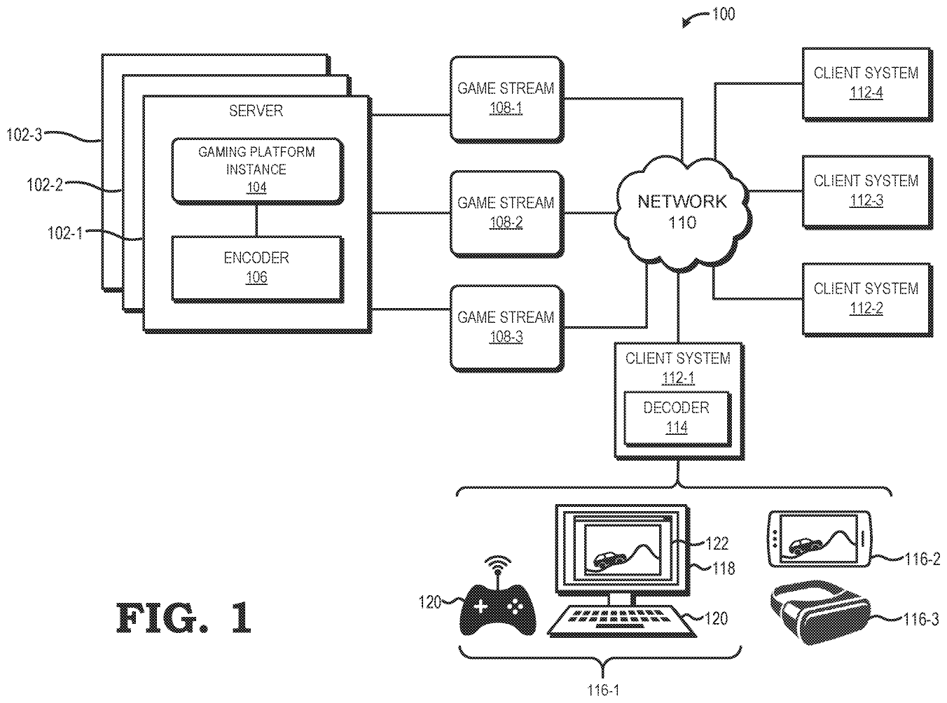

FIG. 1 illustrates a cloud-based gaming system 100 for single-player or multiplayer (including massively multiplayer) gaming, according to some embodiments. Cloud-based gaming system 100 includes one or more servers 102, with each server 102 communicatively coupled to one or more client systems 112 by at least one network 110. Network 110 is configured to allow for the transmission and reception of data between any of servers 102 and client systems 112 and includes, for example, wired and wireless networks, such as Ethernet, the Internet, Wi-Fi, or any combination thereof. In embodiments, each server 102 is communicatively interconnected via a high-bandwidth, low-latency inter-server messaging bus. Servers 102 are typically distributed in one or more data centers over a geographical area so as to reduce transmission latency through physical proximity. Though in the illustrated embodiment, three servers 102-1, 102-2, and 102-3 are presented supporting four client systems 112-1, 112-2, 112-3, and 112-4, in other embodiments, any number of servers may be implemented supporting any number of client devices. It will be appreciated that in a typical real-world implementation, the quantity of servers 102 and quantity of client systems 112 typically will be considerably higher than presented in the example of FIG. 1.

In the depicted embodiment, each server 102 includes a computing device such as, for example, a cloud server, virtual server, or any combination thereof configured to support one or more client gaming sessions executed on one or more client systems 112. A “client gaming session”, as used herein, includes a gaming application being played, partially simulated, or fully simulated on client system 112. Each server 102 is configured to support this client gaming session by executing a corresponding game platform instance 104 that facilitates the execution of at least a portion of the gaming application being played, partially simulated, or fully simulated on the client system 112. Such facilitation can include performing one or more operations related to the gaming application, such as, for example, rendering one or more frames related to the gaming application, performing calculations related to the gaming application (e.g., lighting calculations, artificial intelligence calculation, physics calculations, shading calculations, input calculations, and the like), providing access to files, or any combination thereof, to name a few. The game platform instance 104 provides various software and hardware resources to achieve such facilitation, such as communication/network management, resource management, media rendering encoding, and the like. In this way, game platform instance 104 simulates the execution of one or more operations of the gaming application for a corresponding player as though that gaming application was being played on a local gaming device, such as a personal computer (“PC”), game console, smartphone, tablet computer, automotive entertainment system, and the like.

Each client system 112 represents the hardware and software resources utilized to receive player input through manipulation of one or more input/output devices for at least one player, as well as to present the video and audio content representing the visual and auditory content, respectively, of the gameplay for the at least one player. Examples of a client system 112 include one or more desktop computers, notebook computers, tablet computers, virtual-reality systems, augmented reality systems, a compute-enabled cellular phone (i.e., a “smartphone”), a compute-enabled television (i.e., a “smart TV”), or any combination thereof, to name a few. As illustrated with reference to client system 112-1, each client system 112 includes one or more client devices 116. In the illustrated embodiment, client system 112-1 comprises a first client device 116-1, which is communicatively coupled to, or otherwise associated with, display 118, at least one input device 120 (e.g., a gamepad, joystick, keyboard, mouse, touchscreen), one or more network interfaces configured to couple to the network connecting the client system 112 to a corresponding server 102, one or more processors, memory, storage, speakers, and other computing resources to render, process, and display scenes of a virtual environment. As illustrated with reference to client system 112-1, each client system 112 can include a decoder 114 configured to decode one or more frames related to a virtual environment. Decoder 114 can include hardware and software configured to decode one or more encoding streams (e.g., game streams 108) received from servers 102 so as to produce a decoded set of frames or decoded stream. Each decoder 114 is configured to decode any encoded frame encoded by any method or process disclosed herein. In embodiments, client system 112-1 further comprises a smartphone client device 116-2, and a wearable virtual reality client device 116-3, each of which may operate as an integrated mobile computing device having input facilities, output facilities, display facilities, and communication facilities analogous to those noted above with respect to client system 112-1. In certain embodiments, client systems 112-1, 112-2, and 112-3 may include one or more facilities such as accelerometers, Global Positioning System (GPS) devices, and the like that are used to acquire motion data representing a movement of the client device, as well as a rate or acceleration of such movement.

While certain aspects described herein will be discussed with specific reference to cloud gaming scenarios, it will be appreciated that in certain embodiments the described techniques may be utilized in various non-gaming scenarios, such as if one or more of servers 102 and client systems 112 operate to render, process, and display other types of informational, educational, recreational and/or artistic content. It will therefore be further appreciated that while techniques are discussed herein with respect to the rendering of content that may utilize particular examples relevant to cloud gaming and gaming content, such discussions and techniques may be applied to such non-gaming scenarios. Examples provided herein may refer to scenarios involving the rendering, processing, and display of gaming content due to particular bandwidth and network latency issues relevant to such content and should not be construed to indicate that the techniques described are limited to those scenarios.

During operation, each server 102 executes a gaming platform instance 104 for one or more client gaming sessions. Executing game platform instance 104 includes rendering a set of frames that includes one or more gaming frames associated with the gaming application being executed on one or more respective client systems 112. Each rendered gaming frame depicts at least a portion of a virtual environment used in the gaming application executed on the client system 112. For example, each rendered gaming frame can depict at least a portion of a virtual environment displayed on a display 118 of a client system 112 during the client gaming session.

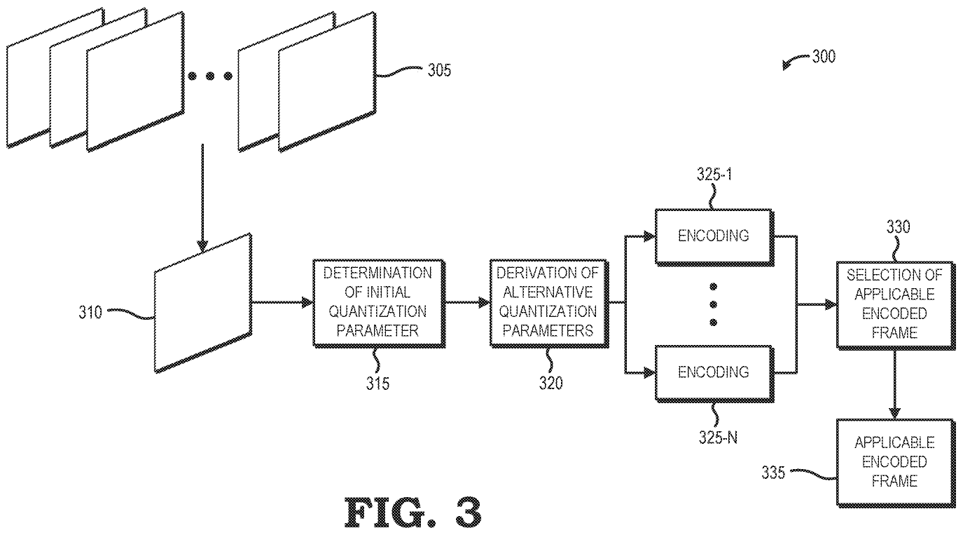

Each server 102 is configured to encode each rendered gaming frame via encoder 106 so as to generate a respective encoded set of frames (also referred to herein as “game stream” 108). Each server 102 is configured to encode a game stream 108 through, for example, compression, reorganization, and manipulation of each frame rendered by gaming platform instance 104. In embodiments, each encoder 106 of a server 102 implements one or more codecs so as to encode one or more rendered frames according to the one or more codecs. Such codecs can include H.264, H.265, VP9, AV1, or any combination thereof, to name a few. According to embodiments, each server 102 is configured to encode each frame rendered by gaming platform instance 104 using a multi-try encoding process which includes performing multiple encodings on a frame and selecting between those multiple encodings according to the current streaming application. As discussed in detail below with reference to FIG. 3, a multi-try encoding process includes determining an initial quantization parameter and alternative quantization parameters for a current frame and performing multiple encodings of the current frame according to the determined initial quantization parameter and the alternative quantization parameters to produce multiple encoded frames. The multi-try encoding process further includes selecting an applicable encoded frame from the multiple encoded frames for inclusion in a resulting game stream 108. Each resulting game stream 108 corresponds to a gaming application being executed on one or more client systems 112 and is provided to these corresponding client systems 112 via network 110. The corresponding client systems 112 are each configured to decode a received game stream 108 via a decoder 114 and display the resulting decoded set of frames 122 on, for example, a display 118. Each client system 112 is configured to decode a respective game stream 108 by compression, reorganization, and manipulation of the frames within the encoded stream according to one or more various video codecs including lossless and lossy codecs. According to embodiments, each client system 112 includes a decoder that implements one or more codecs so as to decode a received game stream 108 according to the one or more codecs. Such codecs can include H.264, H.265, VP9, AV1, or any combination thereof, to name a few. Though three game streams 108-1, 108-2, 108-3 are depicted in the illustrated embodiment, in other embodiments, servers 102 can generate any number of game streams 108 each corresponding to one or more client gaming sessions.

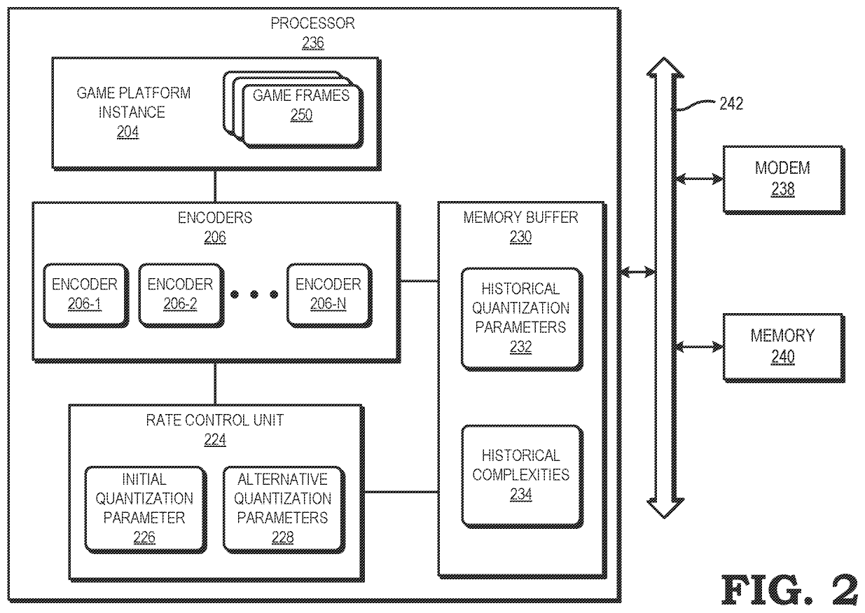

Referring now to FIG. 2, a computing device 200 configured to encode and stream frames within a cloud-based gaming system is illustrated. In embodiments, computing device 200 implements aspects of cloud-based gaming system 100 as described in FIG. 1. For example, computing device 200 may be similar or the same as server 102 described in FIG. 1. Computing device 200 includes one or more software and hardware components for bi-directional communications including components for encoding a set of game frames 250 such as to produce a game stream 108. In some embodiments, computing device 200 is part of an electronic device that supports encoding of a set game frames 250, including, for example, a desktop computer, a notebook computer, a tablet, a server, or a game console, to name a few. In embodiments, computing device 200 includes processor 236, modem 238, and memory 240. Memory 240 includes an electronic storage device, such as for example, a solid-state drive, a hard disk drive, random access memory (“RAM”), read-only memory (“ROM”), electronically erasable programmable ROM (“EEPROM”), optical storage device, or any combination thereof. Memory 240 includes instructions and data related to the operation of game platform instance 204, encoders 206, and rate control unit 224 such as, for example, codecs, reference frames, gaming engines, gaming applications, constants, and the like. Modem 238 is configured to be communicatively coupled to one or more client systems 112 via a network 110 and further configured to transmit a game stream 108 to the one or more client systems 112. According to embodiments, processor 236, modem 238, and memory 240 are internally in electronic communication via one or more interfaces (e.g., a bus 242).

According to embodiments, processor 236 includes one or more control processing units (“CPUs”), microprocessors, field-programmable gate arrays (“FPGAs”), graphics processing units (“GPUs”), application specific integrated circuits (ASICs), or any combination thereof and is configured to render and encode gaming frames for use in a client gaming session on cloud-based gaming system 100. Processor 236 operates to execute a game platform instance 204, the same or similar as game platform instance 104, associated with a current client gaming session and configured to support a gaming application executed on one or more client systems 112. Game platform instance 204 includes graphics hardware and software (not shown for clarity) to render a set of game frames 250 associated with an environment of the gaming application executed on the one or more client devices. Such graphics hardware and software include, for example, graphics cores, processing cores, pixel shaders, video random access memory (“VRAM”), GPUs, physics engines, lighting engines, tessellation engines, and the like. Each rendered game frame of the set of game frames 250 represents at least a portion of a virtual environment associated with the gaming application executed on the client device. For example, if the gaming application is a racing game, each game frame of the set of game frames 250 represents at least a portion of a racetrack, car, or surrounding area.

Each rendered game frame of the set of game frames 250 is provided to encoders 206 for encoding into a game stream 108. Encoders 206 includes one or more software and/or hardware encoders (e.g., encoders 325-1 to 325-N) configured to encode game stream 108 according to, for example, interframe and intraframe techniques. Though in the illustrated embodiment, three encoders 206-1, 206-2, and 206-N are presented, in other embodiments, any number of encoders may be implemented. To reduce the bandwidth needed to transmit a game stream 108 between computing device 200 and one or more client systems 112, encoders 206 encode game stream 108 by compressing one or more game frames of the set of game frames 250. Compressing a game frame includes comparing the game frame to one or more reference frames stored in memory buffer 230 and encoding one or more of the differences between the game frame and the one or more reference frames into game stream 108. Encoders 206 are further configured to encode the reference frames used into game stream 108. In embodiments, encoders 206 are configured to encode game stream 108 based on one or more streaming applications. A “streaming application” as used herein, includes one or more requirements, settings, preferences, or any combination thereof, for a resulting game stream 108 associated with a current client gaming session. These one or more requirements, settings, preferences are based on, for example, a gaming application associated with the client gaming session, hardware capabilities, codecs implemented by encoders 206, or any combination thereof and include, for example, a target quality for the encoded frames of a game stream 108, a target efficiency for the encoded frames of a game stream 108, a target reliability of a game stream 108, or a target latency for a game stream 108. To help assure that a resulting game stream 108 meets one or more requirements, settings, or preferences of the streaming application, encoders 206 are configured to encode each frame according to a rate control scheme so that each encoded frame is compressed to be close in size to a predetermined target bit size. The rate control scheme is implemented by rate control unit 224 which includes one or more processors, hard-coded logic, programmable logic, or any combination thereof, configured to control, or adjust, the bitrate and a number of respective bits (i.e., degree of compression) at which to encode a current frame of the set of game frames 250. Rate control unit 224 controls or adjusts the bitrate and the number of respective bits by determining an applicable quantization parameter (“QP”) for the current frame.

In embodiments, rate control unit 224 determines the applicable QP for a current frame based on a multi-try encoding operation performed by encoders 206. The multi-try encoding operation includes encoders 206 performing multiple encodings on a current frame to produce multiple encoded frames. Each of the encoders 206 performs an encoding on the current frame according to a respective QP to produce multiple encoded frames (i.e., a plurality of encoded frames), with one encoder using an initial QP and one or more other encoders using alternative QPs. For example, a first encoder 206-1 performs an encoding on the current frame using an initial QP and a second encoder 206-2 performs an encoding on the current frame using an alternative QP. Rate control unit 224 then selects an applicable encoded frame from the resulting encoded frames based on the streaming application, with the applicable encoded frame representing the applicable QP (i.e., the QP used to encode the applicable encoded frame). It is important that rate control unit 224 selects an encoded frame from the resulting encoded frames that best meets one or more requirements, settings, or preferences of a streaming application application. For example, rate control unit 224 selects a resulting encoded frame that does not exceed an allowed number of bits based on the available bandwidth.

Rate control unit 224 determines the initial QP for a current frame based on a complexity of the current frame. A “complexity”, as used herein, refers to an amount or value of information in a frame that differs from one or more reference frames associated with the frame (e.g., used to encode the frame). In this way, the higher the complexity of the frame, the more information within the frame exists for the encoders 206 to encode. In embodiments, rate control unit 224 determines an initial QP for a current frame according to the equation:

$$t = ( {a}_{1} / QP + {a}_{2} / {QP}^{2} ) * c \qquad [ EQ 1 ]$$

wherein t represents a predetermined, desired frame size, or degree of compression, for an encoded frame, a₁ and a₂ represent predetermined constants derived from past encoded frames' data, and c represents a complexity, or distortion, of the current frame. In embodiments, rate control unit 224 is configured to determine an estimated complexity for a current frame based upon a first pass encoding of the current frame by encoders 206. In some embodiments, encoders 206 perform the first pass encoding at a lower resolution such as by first downsampling the current frame before the first pass encoding. The first pass encoding produces a first pass encoded frame that includes one or more statistics such as, for example, a bit size of the first pass encoded frame, an energy of the first pass encoded frame, a signal-to-noise ratio of the first pass encoded frame, or any combination thereof, to name a few. According to embodiments, rate control unit 224 is configured to determine an estimated complexity for the current frame based on the statistics of the first pass encoded frame. For example, rate control unit 224 determines an estimated complexity for the current frame based on the bit size of the first pass encoded frame. From the estimated complexity, rate control unit 224 determines an initial QP for the current frame. For example, rate control unit 224 determines an initial QP for the current frame according to the equation presented in EQ1 using the estimated complexity as complexity c.

From the initial QP, rate control unit 224 derives one or more alternative QPs for the current frame. The rate control unit 224 derives the one or more alternative QPs based on the complexities of one or more previously encoded frames from the set of game frames 250 (also referred to herein as “historical complexities” 234), the applicable QPs of one or more previously encoded frames from the set of game frames 250 (also referred to herein as “historical QPs” 232), one or more codecs implemented by encoders 206, or any combination thereof. For example, rate control unit 224 derives one or more alternative QPs for a current frame by comparing the estimated complexity of the frame to one or more historical complexities 234. In embodiments, deriving the alternative QPs includes rate control unit 224 determining whether an alternative QP is to be greater than or less than the initial QP of the current frame. For example, in response to a historical complexity being less than the estimated complexity of the current frame, rate control unit 224 determines that an alternative QP greater than the initial QP is to be derived. Such a determination typically is necessary when an odd number of alternative QPs are to be derived. Deriving the alternative QPs also includes determining one or more differences, or deltas, relative to the initial QP. In embodiments, these differences, or deltas, are based on one or more codecs implemented by encoders 206, hardware specifications, or both. Rate control unit 224 applies the deltas to the initial QP to determine the values for one or more alternative QPs. In other words, rate control unit 224 determines values for alternative QPs relative to the initial QPs according to the determined deltas.

Multiple encoders 206 then perform multiple encodings on the current frame according to the initial QP and the alternative QPs, respectively, to produce a plurality of encoded frames. In embodiments, the encoders 206 performing the multiple encodings are each configured to complete their respective encodings within a predetermined time frame. That is to say, the encoders 206 complete all the multiple encodings within a predetermined time frame. According to embodiments, encoders 206 are configured to perform one or more of the multiple encodings concurrently. Rate control unit 224 then selects an applicable encoded frame from the plurality of encoded frames that best meets one or more requirements, settings, or preferences of a streaming application. In embodiments, rate control unit 224 selects an applicable encoded frame from the plurality of encoded frames by comparing each of the encoded frames to a target bitrate that represents the one or more requirements, settings, or preferences of a streaming application. That is to say, a target bitrate that helps encoders 206 to produce a game stream 108 that meets one or more requirements, settings, or preferences of a streaming application. According to embodiments, rate control unit 224 compares each of the encoded frames to a range derived from a target bitrate and an overshoot factor. An “overshoot factor,” as used herein, represents a tolerance within cloud-based gaming system 100 for overshoots (i.e., when at least a portion of a game stream 108 requires more bandwidth than allowed).

In embodiments, the applicable encoded frame is included in game stream 108 for transmission to one or more client systems 112. According to embodiments, a representation of the complexity for the applicable encoded frame is determined and stored in memory buffer 230 for use as a historical complexity 234 in the encoding of a subsequent frame of the set of game frames 250. Likewise, in embodiments, the applicable QP associated with the applicable encoded frame (i.e., the QP used to encode the applicable encoded frame) is stored in memory buffer 230 for use as a historical QP 232 in the encoding of a subsequent frame of the set of game frames 250.

Referring now to FIG. 3, a flow diagram for a multi-try encoding operation 300 is illustrated. For ease of illustration, the multi-try encoding operation 300 is described with reference to the computing device 200 of FIG. 2 implemented as a server 102 in the cloud-based gaming system 100 of FIG. 1. In operation 300, the game platform instance 204 renders a set of frames 305 for a client gaming session associated with a gaming application running on one or more client systems 112. Each frame of the set of frames 305 represents at least a portion of a virtual environment related to the gaming application. To facilitate the transmission of the set of frames 305 to the client system executing the gaming application, encoders 206 encode each frame of the set of frames 305 using a multi-try encoding operation 300. In doing so, the resulting game stream 108 can better meet the one or more requirements, settings, or preferences of a streaming application. For example, the bandwidth of a resulting game stream 108 can be more closely matched to the actual available bandwidth.

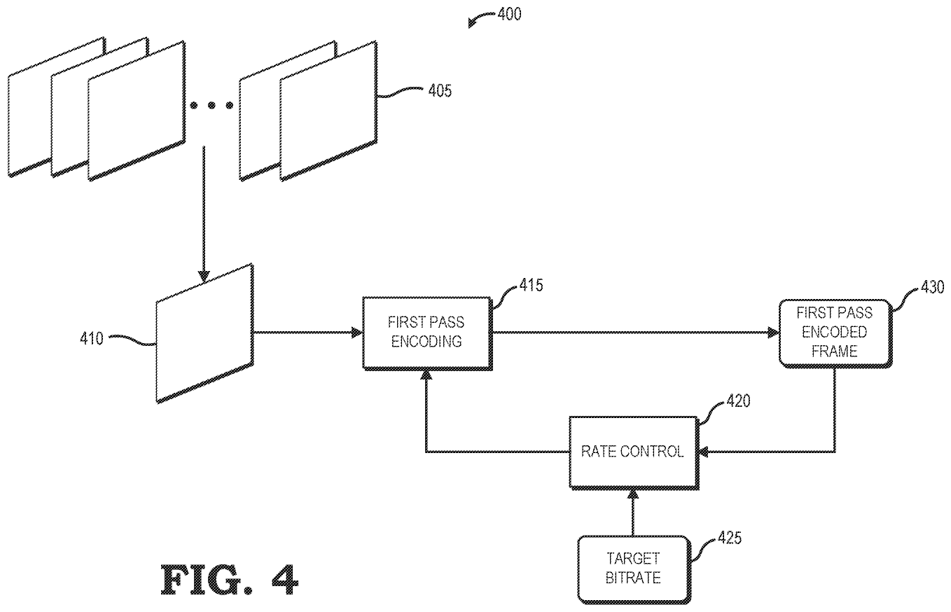

For a current frame (also referred to herein as a “first frame”) 310 of the set of frames 305, rate control unit 224 performs a determination 315 of an initial quantization parameter for the current frame 310. In embodiments, rate control unit 224 performs the determination 315 of an initial quantization parameter for the current frame 310 based on a first pass encoding of the current frame (i.e., first frame) 310. For example, referring now to FIG. 4, a flow diagram of an example determination 400 of an initial quantization parameter is illustrated. For a current frame (also referred to herein a “first frame”) 410 of a set of frames 405, similar or the same as current frame 310 and set of frames 305, respectively, the encoders 206 perform a first pass encoding 415 based on rate control 420. Rate control 420 includes rate control unit 224 determining initial QPs for the one or more encoders 206 to encode the set of frames 405. For the current frame (i.e., first frame) 410, rate control unit 224 first determines a first pass QP based on one or more codecs implemented by encoders 206, target bitrate 425, or both. Target bitrate 425 represents a bitrate for a resulting game stream 108 that helps the game stream 108 meet the one or more requirements, settings, or preferences of the streaming application. According to some embodiments, the first pass QP is a constant value determined from the codecs implemented by the encoders 206. After rate control unit 224 has determined the first pass QP, encoders 206 perform the first pass encoding 415 on the current frame 410 according to the first pass QP so to produce a first pass encoded frame 430. The first pass encoded frame 430 includes one or more statistics such as, for example, the bit size of the first pass encoded frame, an energy of the first pass encoded frame, a signal-to-noise ratio of the first pass encoded frame, or any combination thereof, to name a few. Based on the statistics of the first pass encoded frame 430 and the target bit rate, rate control unit 224 adjusts the rate control 420 by determining an initial QP for the current frame 410. That is to say, rate control unit 224 determines an initial QP for the current frame 410 based on the statistics of the first pass encoded frame 430 and the target bit rate. According to embodiments, determining an initial QP includes rate control unit 224 determining an estimated complexity of the current frame 410 according to the statistics of the first pass encoded frame 430. For example, rate control unit 224 determines an estimated complexity for the current frame 410 based on the bit size of the first pass encoded frame 430. In embodiments, rate control unit 224 then determines an initial QP from the estimated complexity and the target bitrate 425.

Referring again to FIG. 3, after an initial QP is determined for the current frame 310, rate control unit 224 performs a derivation 320 of one or more alternative QPs for the current frame 310. According to embodiments, rate control unit 224 performs the derivation 320 of one or more alternative QPs based on the initial QP produced from the determination 315. In embodiments, rate control unit 224 performs the derivation 320 of one or more alternative QPs by first determining the number of alternative QPs to produce. In other words, rate control unit 224 determines how many alternative QPs are to be derived from the initial QP. In some embodiments, the number of alternative QPs is a predetermined value. According to embodiments, rate control unit 224 determines whether one or more of the alternative QPs to be derived will be greater than the initial QP or less than the initial QP. For example, when the number of alternative QPs to be derived is 1, rate control unit 224 determines whether that alternative QP will be greater or less than the initial QP. That is to say, for example, rate control unit 224 selects between a candidate alternative QP greater than the initial QP and a candidate alternative QP less than the initial QP. Rate control unit 224 determines whether one or more of the alternative QPs will be greater than the initial QP or less than the initial QP by comparing one or more historical complexities 234 associated with the set of frames 305 to the estimated complexity of the current frame 310, comparing one or more historical QPs 232 associated with the set of frames 305 to the initial QP of the current frame 310, or both. In embodiments, this comparison includes, for example, determining one or more trends, averages, modes, medians, or any combination thereof, in the historical complexities 234 and historical QPs 232 and comparing those trends, averages, modes, medians, or any combination thereof, to an estimated complexity or initial QP of the current frame 310. For example, comparing one or more historical complexities 234 associated with the set of frames 305 to the estimated complexity of the current frame 310 includes determining an average for one or more historical complexities 234 and comparing the average to the estimated complexity of the current frame 310. Based on the comparison of the one or more historical complexities 234 associated with the set of frames 305 to the estimated complexity of the current frame 310 or the one or more historical QPs 232 associated with the set of frames 305 to the initial QP of the current frame 310, rate control unit 224 determines whether one or more of the alternative QPs will be greater than the initial QP or less than the initial QP (e.g., selects between a first candidate alternative QP greater than the initial QP and a second candidate alternative QP less than the initial QP). For example, in response to the comparison indicating that the current frame 310 has a higher complexity than previously encoded frames from the set of frames 305, rate control unit 224 determines that one or more of the alternative QPs will be greater than the initial QP, such as, for example, to compensate for the increase in complexity. Likewise, for example, in response to the comparison indicating that the current frame 310 has a lower complexity than previous encoded frames from the set of frames 305, rate control unit 224 determines that one or more of the alternative QPs will be less than the initial QP. As another example, in response to the initial QP of the current frame 310 being less than one or more historical QPs 232, rate control unit 224 determines that one or more of the alternative QPs will be greater than the initial QP such as, for example, to aid in avoiding overshoots in the resulting game stream 108.

In embodiments, rate control unit 224 further derives the alternative QPs by determining one or more differences, or deltas, relative to the initial QP. In embodiments, these differences, or deltas, are based on one or more codecs implemented by encoders 206, hardware, or both. Based on these deltas, rate control unit 224 determines the values for one or more alternative QPs. In other words, rate control unit 224 determines values for alternative QPs relative to the initial QPs according to the determined deltas.

After rate control unit 224 determines the one or more alternative QPs for the current frame 310, encoders 206 perform multiple encodings 325-1 to 325-N on the current frame according to the initial QP and the alternative QPs to produce a plurality of encoded frames. According to embodiments, respective encoders of encoders 206 perform an encoding 325 according to either the initial QP or a respective alternative QP. For example, encoder 206-1 performs an encoding 325 on the current frame 310 according to the initial QP, and encoder 206-2 performs an encoding 325 on the current frame 310 according to an alternative QP. In embodiments, encoders 206 are configured to perform all the encodings 325-1 to 325-N within a predetermined time frame or amount of time. Further, in some embodiments, encoders 206 are configured to perform one or more of the encodings 325 concurrently.

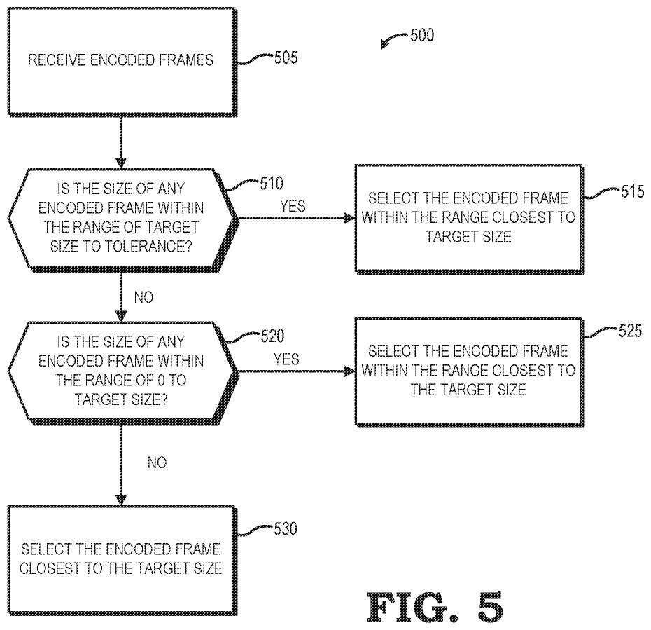

From the resulting encoded frames produced by the multiple encodings 325, rate control unit 224 performs a selection 330 of an applicable encoded frame according to the streaming application. For example, rate control unit 224 selects the encoded frame that best helps the resulting game stream 108 meet the one or more requirements, settings, or preferences of the streaming application. In embodiments, rate control unit 224 selects the applicable encoded frame based on the target bitrate and a tolerance associated with the cloud-based gaming system 100. As an example, referring now to FIG. 5, an example selection 500 of an applicable encoding is presented. At block 505, rate control unit 224 receives the plurality of encoded frames produced from the multiple encodings 325. At block 510, rate control unit determines whether any of the encoded frames of the plurality of encoded frames have a size between a target frame size and a tolerance. That is to say, rate control unit 224 determines whether there is a group of encoded frames within the plurality of encoded frames that each have a size between a target frame size and a tolerance. In some embodiments, rate control unit 224 determines the target frame size based on the target bitrate with the target frame size indicating how many bits an encoded frame is allowed without exceeding the available bandwidth. The tolerance represents the number of bits the cloud-based gaming system 100 can tolerate according to its overshoot factor. In embodiments, rate control unit 224 determines the tolerance according to the equation:

$$Tolerance = f * T \qquad [ EQ 2 ]$$

wherein f represents the overshoot factor for the cloud-based gaming system 100 and T represents the target frame size. If any of the encoded frames from the plurality of encoded frames has a size between the target frame size and the tolerance (e.g., between [T, Tolerance]), rate control unit 224 moves to block 515. At block 515, from the group of encoded frames having a size between the target frame size and the tolerance, rate control unit 224 selects the encoded frame closest in size to the target frame size to produce applicable encoded frame 335. If none of the encoded frames from the plurality of encoded frames have a size between the target frame size and the tolerance rate, rate control unit 224 moves to block 520.

At block 520, rate control unit 224 determines whether the size of any of the encoded frames is between 0 and the target size (e.g., between [0, T]). That is to say, rate control unit 224 determines whether there is a group of encoded frames within the plurality of encoded frames that each have a size between 0 and a target frame size. If any of the encoded frames from the plurality of encoded frames have a size between 0 and the target frame size, rate control unit 224 moves to block 525. At block 525, from the group of encoded frames having a size between 0 and the target size, rate control unit 224 selects the encoded frame having a size closest to the target frame size to produce applicable encoded frame 335. If none of the encoded frames from the plurality of encoded frames have a size between 0 and the target frame size, rate control unit 224 moves to block 530. At block 530, from the plurality of encoded frames (i.e., all the encoded frames produced during the multiple encodings), rate control unit 224 selects the encoded frame having a size closest to the target bitrate to produce applicable encoded frame 335.

Referring again to FIG. 3, in embodiments, the applicable encoded frame 335 is transmitted as part of a resulting game stream 108 to one or more client systems 112. According to embodiments, rate control unit 224 stores the applicable QP of the applicable encoded frame 335 (i.e., the QP used to encode the applicable encoded frame 335) in memory buffer 230 for use as a historical QP 232 to encode subsequent frames from the set of frames 305. In embodiments, rate control unit 224 determines a complexity for the applicable encoded frame 335 based on the applicable QP, the reference frames used to encode the applicable encoded frame 335, or both. Rate control unit 224 stores the determined complexity for the applicable encoded frame 335 in memory buffer 230 for use as a historical complexity 234 to encode subsequent frames from the set of frames 305.

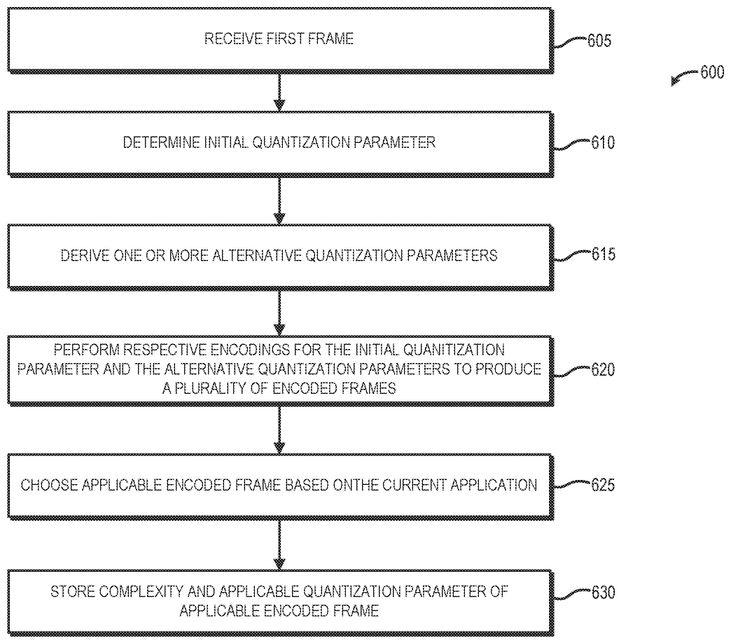

Referring now to FIG. 6, a flow diagram illustrating an example multi-try encoding method 600 is presented. For ease of illustration, the method 600 is described with reference to the computing device 200 of FIG. 2 implemented as a server 102 of the system 100 of FIG. 1. At block 605, encoders, the same or similar as the encoders 206, receive a current frame (i.e., a first frame). The current frame represents at least a portion of a virtual environment associated with a client gaming session. At block 610, a rate control unit, similar or the same as rate control unit 224, determines an initial QP for the current frame. In embodiments, the rate control unit determines the initial QP based on an estimated complexity of the current frame and a target bitrate. The target bitrate represents a bitrate that aids in a resulting game stream 108 meeting the one or more requirements, settings, or preferences of a streaming application. According to embodiments, the rate control unit determines an estimated complexity of the current frame based on a first pass encoding of the current frame performed by the encoders. From the first pass encoding, the encoders produce a first pass encoded frame including one or more statistics such as, for example, the bit size, an energy, a signal-to-noise ratio, or any combination thereof, of the first pass encoded frame, to name a few. Based on the statistics of the first pass encoded frame, the rate control unit determines an estimated complexity for the current frame which is then used to determine an initial QP for the current frame.

At block 615, after determining an initial QP for the current frame, rate control unit 224 derives one or more alternative QPs for the current frame based on the initial QP. In embodiments, the rate control unit determines whether one or more alternative QPs will be greater or less than the initial QP for the current frame. For example, the rate control unit selects between a first candidate alternative QP greater than the initial QP and a second candidate alternative QP less than the initial QP. One of ordinary skill in the art will appreciate that such a determination is necessary when an odd number of alternative QPs are derived, such as, for example, when only one alternative QP is derived. According to embodiments, the rate control unit determines whether one or more alternative QPs will be greater or less than the initial QP based on a comparison of the estimated complexity of the current frame to one or more historical complexities 234, a comparison of the initial QP for the current frame to one or more historical QPs 232, or both. For example, in response to the initial QP for the current frame being less than one or more historical QPs 232, rate control unit 224 determines that an alternative QP will be greater than the initial QP such as, for example, to help prevent overshoots in the resulting game stream 108. According to embodiments, the rate control unit also determines one or more differences, or deltas, relative to the initial QP. In embodiments, these differences, or deltas, are based on one or more codecs implemented by the encoders, hardware specification, or both. Based on these deltas, the rate control unit determines the values for one or more alternative QPs relative to the initial QP.

At block 620, the encoders perform multiple, distinct encodings on the current frame according to the initial QP and the alternative QPs to produce a plurality of encoded frames. In embodiments, the multiple encodings include one or more respective encoders encoding the current frame according to the initial QP and one or more respective alternative QPs. According to embodiments, the encoders perform all of the multiple encodings within a predetermined amount of time. Further, in embodiments, one or more encoders perform their respective encodings concurrently. At block 625, the rate control unit selects an encoded frame from the plurality of encoded frames according to the streaming application to produce an applicable encoded frame. That is to say, the rate control unit selects an applicable encoded frame that best helps game stream 108 meet one or more requirements, settings, or preferences of a streaming application. In embodiments, selecting the applicable encoded frame includes the rate control unit determining whether the size of one or more encoded frames of the plurality of encoded frames are within ranges based on a target frame size determined from the target bitrate and a tolerance. In other words, the rate control unit determines whether any sub-groups of encoded frames from the plurality of encoded frames are within these ranges. For example, the rate control unit determines whether the size of any encoded frames from the plurality of encoded frames is between the target frame size and the tolerance or between 0 and the target frame size. In response to the rate control unit determining that the size of one or more encoded frames is within a range, the rate control unit then selects the encoded frame from the sub-group closest in size to the target frame size to produce the applicable encoded frame. In response to the rate control unit determining that the size of none of the encoded frames of the plurality of encoded frames is within a range, the rate control unit selects the encoded frame from the plurality of encoded frames closest in size to the target frame size to produce the applicable encoded frame.

At block 630, the rate control unit determines a complexity for the applicable encoded frame based on the target bit rate, the reference frames used to encode the applicable encoded frame, or both. The complexity is then stored in a memory buffer (such as by storing a representation of the complexity in the memory buffer), similar to or the same as memory buffer 230, for use as a historical complexity for encoding a subsequent frame from the set of frames. Likewise, the rate control unit stores the applicable QP of the applicable encoded frame (i.e., the QP used to encode the applicable encoded frame) in the memory buffer for use as a historical QP for encoding a subsequent frame from the set of frames. A computer device, the same or similar as computing device 200, transmits the applicable encoded frame to one or more client systems 112 as part of game stream 108.

In some embodiments, certain aspects of the techniques described above may be implemented by one or more processors of a processing system executing software.

The software comprises one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM), or other non-volatile memory device or devices, and the like. The executable instructions stored on the non-transitory computer-readable storage medium may be in source code, assembly language code, object code, or other instruction format that is interpreted or otherwise executable by one or more processors.

A computer-readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A computer-implemented method, comprising:
determining an initial quantization parameter associated with a first frame of a set of frames;
deriving an alternative quantization parameter for the first frame based on the initial quantization parameter;
performing both a first encoding of the first frame using the initial quantization parameter to produce a first encoded frame and a second encoding of the first frame using the alternative quantization parameter to produce a second encoded frame;
selecting between the first encoded frame and the second encoded frame for transmission as part of an encoded game stream in response to a comparison of the first encoded frame and the second encoded frame to a target frame size; and
transmitting the encoded game stream.

2. The method of claim 1, wherein determining the initial quantization parameter comprises:
performing a first pass encoding on the first frame to produce a first pass encoded frame; and
determining the initial quantization parameter based on the first pass encoded frame.

3. The method of claim 2, determining the initial quantization parameter further comprises:
determining an estimated complexity for the first frame based on a statistic of the first pass encoded frame; and
determining the initial quantization parameter based upon the estimated complexity.

4. The method of claim 3, wherein deriving the alternative quantization parameter comprises:
determining a historical complexity associated with at least one other frame of the set of frames; and
comparing the historical complexity to the estimated complexity of the first frame.

5. The method of claim 4, wherein deriving the alternative quantization parameter further comprises:
selecting the alternative quantization parameter between a first candidate alternative quantization parameter and a second candidate alternative quantization parameter in response to the comparison of the historical complexity to the estimated complexity of the first frame, wherein the first candidate alternative quantization parameter is greater than the initial quantization parameter and the second candidate alternative quantization parameter is less than the initial quantization parameter.

6. The method of claim 5, wherein deriving the alternative quantization parameter further comprises:
in response to the historical complexity being greater than the estimated complexity of the first frame, selecting the second alternative quantization parameter.

7. The method of claim 5, wherein deriving the alternative quantization parameter further comprises:
in response to the historical complexity being less than an estimated complexity of the first frame, selecting the first alternative quantization parameter.

8. The method of claim 5, wherein determining a historical complexity associated with at least one other frame of the set of frames comprises calculating an average for one or more historical complexities of previously encoded frames of the set of frames and comparing the average to the estimated complexity of the first frame currently to be encoded.

9. A computer-implemented method, comprising:
performing a first pass encoding on a first frame of a set of frames for a streaming application;
determining an initial quantization parameter based on the first pass encoding;
deriving an alternative quantization parameter for the first frame based on at least one other frame of the set of frames;
performing a first encoding of the first frame using the initial quantization parameter to produce a first encoded frame and performing a second encoding of the first frame using the alternative quantization parameter to produce a second encoded frame;
selecting between the first encoded frame and the second encoded frame for transmission as part of an encoded game stream based on the streaming application; and
transmitting the encoded game stream.

10. The method of claim 9, wherein determining an initial quantization parameter based on the first pass encoding comprises:
determining an estimated complexity for the first frame based on the first pass encoding.

11. The method of claim 10, wherein deriving an alternative quantization parameter for the first frame based on at least one other frame of the set of frames comprises:
determining a historical complexity associated with the at least one other frame; and
comparing the estimated complexity to the historical complexity.

12. The method of claim 11, wherein deriving an alternative quantization parameter for the first frame based on at least one other frame of the set of frames further comprises:
in response to the historical complexity being greater than the estimated complexity, determining a value for the alternative quantization parameter less than the initial quantization parameter; and
in response to the historical complexity being less than the estimated complexity, determining a value for the alternative quantization parameter greater than the initial quantization parameter.

13. The method of claim 9, wherein the streaming application comprises at least one of a target size, a target efficiency, a target reliability, or a target latency.

14. The method of claim 9, wherein selecting between the first encoded frame and the second encoded frame for transmission in an encoded stream based on the streaming application further comprises:
determining a target frame size based on the streaming application; and
comparing each of the first and second encoded frames to the target frame size.

15. The method of any of claim 1, wherein the alternative quantization parameter is one of a plurality of alternative quantization parameters.

16. The method of claim 15, further comprising:
deriving the plurality of alternative quantization parameters according to the set of frames.

17. The method of claim 1, wherein the encoded game stream is encoded for a target bitrate.

18. The method of claim 17, further comprising:
comparing each the first and second encoded frames to the target bitrate; and
selecting between the first encoded frame and the second encoded frame further in response to the comparison of each the first and second encoded frames to the target bitrate.

19. The method of claim 1, wherein the encoded game stream is associated with a gaming session.

20. The method of claim 19, wherein the first frame represents at least a portion of a virtual environment associated with the gaming session.

21. The method of claim 19, wherein the encoded game stream is transmitted to a client device associated with the gaming session.

22. The method of any of claim 1, further comprising:
decoding the encoded game stream to produce a decoded game stream; and
displaying the decoded game stream.

23. The method of claim 1, wherein the first encoding and the second encoding are both performed within a predetermined duration.

24. The method of claim 1, wherein the first encoding and the second encoding are performed concurrently.

25. The method of claim 1, further comprising:
determining a complexity of the selected encoded frame; and
storing a representation of the complexity in a memory buffer.

26. The method of claim 25, further comprising:
performing a second encoding of a second frame of the set of frames based on the stored representation of the complexity.

27. (canceled)

28. (canceled)

29. (canceled)

30. (canceled)
